(19) United States
(12) Patent Application Publication
(10) Pub. No.: US 2024/0147288 A1
(43) Pub. Date: May 2, 2024

(54) ENHANCED WIRELESS DEVICE MEASUREMENT GAP PRE-CONFIGURATION, ACTIVATION, AND CONCURRENCY

(71) Applicant: INTEL CORPORATION, Santa Clara, CA (US)

(72) Inventors: Rui HUANG, Beijing (CN); Andrey CHERVYAKOV, Nizhny Novgorod (RU); Hua LI, Beijing (CN); Candy YIU, Portland, OR (US); Meng ZHANG, Beijing (CN)

(21) Appl. No.: 18/548,874

(22) PCT Filed: Mar. 31, 2022
(86) PCT No.: PCT/US2022/022963

§ 371 Date: Sep. 1, 2023

Related U.S. Application Data
(60) Provisional application No. 63/169,706, filed on Apr. 1, 2021.
(60) Provisional application No. 63/169,749, filed on Apr. 1, 2021.
(60) Provisional application No. 63/169,780, filed on Apr. 1, 2021.
(60) Provisional application No. 63/173,277, filed on Apr. 9, 2021.

(51) Int. Cl. H04W 24/10; H04L 5/00; H04W 72/0453; H04W 72/0457

(52) U.S. Cl. CPC H04W 24/10; H04L 5/0051; H04W 72/0453; H04W 72/0457

(57) ABSTRACT

This disclosure describes systems, methods, and devices related to measurement gaps. A user equipment (UE) device may identify a configuration message, received from a 5G network device prior to switching from an active bandwidth part (BWP), for a pre-configured measurement gap during which the UE device is to perform an both gapless and gap-based frequency measurements, the configuration message indicating that the pre-configured measurement gap requires activation; identify an activation of the pre-configured measurement gap; and measure a reference signal during the pre-configured measurement gap.

### CROSS-REFERENCE TO RELATED PATENT APPLICATION(S)

This application claims the benefit of U.S. Provisional Application No. 63/169,706, filed Apr. 1, 2021, of U.S. Provisional Application No. 63/169,749, filed Apr. 1, 2021, of U.S. Provisional Application No. 63/169,780, filed Apr. 1, 2021, and of U.S. Provisional Application No. 63/173,277, filed Apr. 9, 2021, the disclosures of which are incorporated by reference as set forth in full.

### TECHNICAL FIELD

This disclosure generally relates to systems and methods for wireless communications and, more particularly, to wireless device measurement gap pre-configuration, activation, and concurrency for 5^{th} Generation (5G) communications.

### BACKGROUND

Wireless devices are becoming widely prevalent and are increasingly using wireless channels. The 3^{rd} Generation Partnership Program (3GPP) is developing one or more standards for wireless communications.

### BRIEF DESCRIPTION OF THE DRAWINGS

FIG. 1 is a network diagram illustrating an example process for using multiple concurrent measurement gaps, according to some example embodiments of the present disclosure.

FIG. 2 is a network diagram illustrating an example process for using pre-configured measurement gaps, according to some example embodiments of the present disclosure.

FIG. 3 illustrates a flow diagram of illustrative process for using pre-configured measurement gap activation indications, in accordance with one or more example embodiments of the present disclosure.

FIG. 4A illustrates a flow diagram of illustrative process for using pre-configured measurement gaps, in accordance with one or more example embodiments of the present disclosure.

FIG. 4B illustrates a flow diagram of illustrative process for using multiple concurrent measurement gaps, in accordance with one or more example embodiments of the present disclosure.

FIG. 4C illustrates a flow diagram of illustrative process for using multiple independent measurement gaps, in accordance with one or more example embodiments of the present disclosure.

FIG. 5 illustrates a network, in accordance with one or more example embodiments of the present disclosure.

FIG. 6 schematically illustrates a wireless network, in accordance with one or more example embodiments of the present disclosure.

FIG. 7 is a block diagram illustrating components, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless devices may perform measurements as defined by technical standards. For cellular telecommunications, the 3^{rd} Generation Partnership Program (3GPP) define communication techniques, including for device measurements, such as inter-frequency measurements, intra-frequency measurements, and inter-radio access technology (RAT) measurements.

In particular, the 3GPP standards define the concept of a measurement gap during which a user equipment device (UE) may perform measurements when it cannot measure a target carrier frequency while sending or receiving on a serving cell. Measurement gaps may be periodic (e.g., repetitive with a periodic cycle). Different from LTE intra-frequency measurements, measurement gaps may be needed for intra-frequency measurements in some situations (e.g., when the measurements are to be performed outside of the active bandwidth part).

In Release 17 of the 3GPP standards, the concept of multiple concurrent measurement gaps is provided, allowing for multiple measurement gaps for a UE to occur during a time period. Previously, only one measurement gap was allowed per UE during the time period.

In addition, the 5G network previously pre-configured the measurement gap to avoid scheduling data transmissions during the measurement gap, but the new release allows the network to be triggered to communicate with a UE during the measurement gap time period (e.g., to request the UE to activate). There is a need to pre-configure the measurement gap to allow this to occur, to activate the pre-configured measurement gap, and to provide an activation indication for the measurement gap.

In one or more embodiments, the present disclosure considers an impact of the TX/RX timing errors on the accuracy of the DL-TDOA, UL-TDOA, and Multi-RTT positioning methods. The present disclosure provides a method for estimation and compensation of the UE TX/RX and gNB TX/RX timing errors, and Information Element (IE) formats to support the reporting of such measurements for use in enhanced positioning techniques. The enhancements herein apply to TDOA and RTT techniques.

In one or more embodiments, a 5G network may configure multiple concurrent measurement gaps for a UE during a time period. The multiple concurrent gaps may be for a limited, specific time duration, and the time duration may be up to all measurement gap periodicity (e.g., which may be configured by the network for the UE). The network may configure the multiple concurrent measurement gaps independently from one another. The measurement gap patterns may be selected from Release 16 measurement gap patterns (e.g., 0-25). Regarding the measurement gaps being independent from one another, the gaps may be considered independent if at least one of the configurations in measurement gap length (MGL), measurement gap repetition period (MGRP), and/or time offset is different. Measurement gaps may be considered independent if they can operate simultaneously without impacting measurement performance requirements of the other gaps.

In one or more embodiments, the time period during which concurrent measurement gaps may be configured may be referred to as a common period. Generally, multiple concurrent measurement gaps may allowing a serving gNB to configure more than one gap within a specific time period, which may depend on the maximum MGRP of all UE configured gaps. Similarly, the common period may be the concurrent measurement gap's life cycle. Accordingly, the common period should not be shorter than any individual gaps included in the concurrent measurement gaps. In one option, the common period may be the maximum value of MGRPi, which may represent the measurement periodicity if the ith individual measurement gap configured within the concurrent measurement gaps. The maximum MGRP may be 160 ms, as defined in Release 17. In another option, the concurrent gaps may be composed of individual gap instances, which can be independent of each other whether their MGRP or MGL are different, because they are targeted to use for different measurement objects or layers (e.g., a UE may be configured with multiple measurement gaps when the “multiple concurrent gap” capability is supported).

In one or more embodiments, the network may configure a pre-configured measurement gap (e.g., fasten gap). The preconfigured measurement gaps may be configured before a UE switches its activated bandwidth part (BWP), and may be configured to associate with specific measurement objects that may be valid before and after UE BWP switching, and that may be defined by the frequency layer. The pre-configured measurement gaps may be per UE and per frequency range (FR)., and may be configured to associate with the BWP or for all BWPs to be activated.

In one or more embodiments, when the network configures measurement gaps, the network may communicate with the UE during the measurement gap in some situations. For example, measurement gaps may be activated or deactivated following a DCI or timer-based BWP switch (e.g., per BWP measurement gap configuration). The network may configure the pre-configured measurement gap, activate the pre-configured measurement gap (e.g., when BWP switching), and deactivate the pre-configured measurement gap. A purpose of a pre-configured measurement gap is to accommodate the measurement gap configuration based on dynamic situations for intra-frequency measurements with BWP switching. In contrast with legacy measurement gaps, pre-configured measurement gaps may need further activation when BWP switching. The configuration procedure for pre-configured measurement gaps may follow the mechanism of “MeasGapConfig” from Release 16, which defines measurement gaps associated with MOs themselves. A “PreConfigMG” mechanism (e.g., PreConfigMG=true) may differentiate a pre-configured measurement gap from a legacy measurement gap using MeasGapConfig.

In one or more embodiments, a measurement gap may be per BWP (e.g., on or off for specific BWPs). For example, for a MeasGapConfig, a measurement gap may be activate or not for a UE per BWP based on signalling in the MeasGapConfig for each BWP.

In one or more embodiments, the 5G network may activate pre-configured measurement gaps, autonomously by the gNB and UE. The gNB may not schedule within the pre-configured measurement gaps after BWP switching. The UE may perform the measurement on target MOs with the pre-configured measurement gap autonomously after BWP switching. A bit may be used to indicate or register a pre-configured measurement gaps activation, and may be provided to the UE by the gNB (e.g., based on a UE's request or without such a request).

In one or more embodiments, a gNB may configure pre-configured measurement gaps before the UE's active BWP switching is triggered. The gNB may not schedule any data within the pre-configured measurement gap after BWP switching. The pre-configured measurement gap configuration may be associated with a measurement object such as a frequency carrier. The pre-configured measurement gap configuration may include basic gap pattern information such as measurement length and measurement periodicity, and the activation indication for possible UE BWPs. The activation indication may be a flag to distinguish from legacy measurement gap configurations (e.g., may be the PreConfigMG flag), or may be a bitmap for all possible BWPs (e.g., N bits for N candidate BWPs). The UE may perform the measurement on target MOs with the pre-configured measurement gap if the activation indication for the BWP switch is true. The UE's candidate BWP may be reconfigured by the RRC (e.g., DowlinkConfigCommon), and the indication bits may be updated by the RRC. When the UE's MO is reconfigured, the indication bits may be updated by the same RRC.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

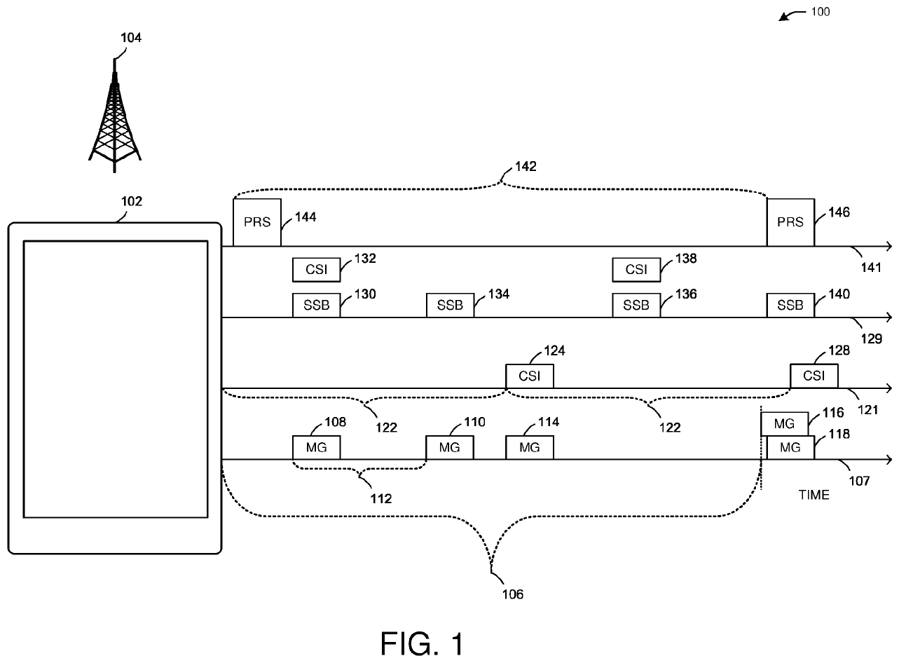

FIG. 1 is a network diagram illustrating an example process 100 for using multiple concurrent measurement gaps, according to some example embodiments of the present disclosure.

Referring to FIG. 1, the process 100 may include a UE device 102 and a 5G network device (e.g., a gNB 104). During a common time period 106, the UE device 102 may be configured by the gNB 104 to use multiple concurrent measurement gaps (e.g., in a serving cell frequency 107-frequency f0) during which to perform frequency measurements. For example, a first measurement gap 110 and a second measurement gap 112 may have a periodicity of MGRP 108, and may be used to measure reference signals as explained further below. A third measurement gap 114 may be used to measure a reference signal as explained further below. After the common time period 106, the UE device 102 may use measurement gap 116 to measure a reference signal, and may use a measurement gap 118 to measure a reference signal as explained further below. As an example, the measurement gap 116 and the measurement gap 118 are shown as overlapping in time. The reference signals may be sent by the gNB 104.

Still referring to FIG. 1, in a neighboring cell frequency 121 (e.g., frequency f2), a MGRP 122 may define the periodicity of CSI transmissions (e.g., CSI 124 and CSI 128). During the measurement gap 108, the UE device 102 may measure, in a neighboring cell frequency 129 (e.g., frequency f1), a SSB 130 (and corresponding channel state information (CSI) 132 as a reference signal, the SSB 130 and the CSI 132 being in a same frequency f1, but in different BWPs). The UE device 102 may measure, in the neighboring cell frequency 129, a SSB 134 during the measurement gap 110. SSB 136 and CSI 138 may be sent using the neighboring cell frequency 129 during the common time period 106. The UE device 102 may measure the SSB 140, using the neighboring cell frequency 129, during the measurement gap 118. Using a neighboring cell frequency 141, the UE device 102 may receive a positioning reference signal (PRS) 144 and a PRS 146, defined by a MGRP 148 periodicity. The UE device 102 may measure the PRS 146 during the measurement gap 116.

In one or more embodiments, the gNB 104 may configure the concurrent measurement gaps for the UE device 102 during the common time period 106. The common time period 106 should not be shorter than any individual measurement gap during the common time period 106. The duration of the common time period 106 may be a function of max(MGRPi), where MGRPi is the measurement periodicity of the ith individual measurement gap within the common time period 106. A concurrent measurement gap may refer to multiple measurement gaps valid for a same UE's measurements during the common time period 106. The concurrent measurement gaps may include individual gap instances that may be independent of one another whether or not their MGRPs or MGLs are different because they are targeted for use of different measurement objects or layers (e.g., the UE device 102 may be configured with multiple measurement gaps when the capability of “multiple concurrent gaps” is supported by the UE device 102).

The UE 102 may include any suitable processor-driven device including, but not limited to, a mobile device or a non-mobile, e.g., a static device. For example, the UE 102 may include, a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

Any of the UE 102 and the gNB 104 may include one or more communications antennas. The one or more communications antennas may be any suitable type of antennas corresponding to the communications protocols used by the UE 102 and the gNB 104. Some non-limiting examples of suitable communications antennas include 3GPP antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the UE 102 and the gNB 104.

It is understood that the above descriptions are for purposes of illustration and are not meant to be limiting.

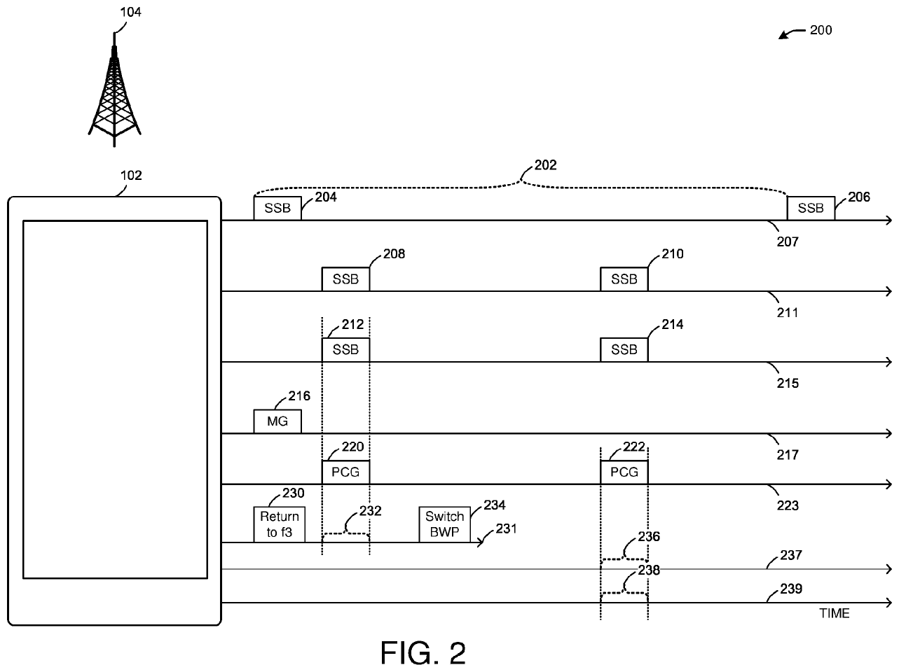

FIG. 2 is a network diagram illustrating an example process 200 for using pre-configured measurement gaps, according to some example embodiments of the present disclosure.

Referring to FIG. 2, the UE device 102 may be in communication with the gNB 104 of FIG. 1. The UE device 102 may, during a SSB-based Measurement Timing Configuration (SMTC) 202, receive a SSB 204 (e.g., from the gNB 104). The SMTC 202 may define a period between the SSB 206 and the SSB 206 from the gNB 104 using a neighboring cell frequency 207 (e.g., frequency f3). The UE device 102 may receive a SSB 208 and a SSB 210 (e.g., from the gNB 104) using a neighboring cell frequency 211 (e.g., frequency f2), and may receive a SSB 212 and a SSB 214 (e.g., from the gNB 104) using a neighboring cell frequency 215 (e.g., frequency f1). The SSB 208 and the SSB 212 may be offset in time from the SSB 204 (e.g., by one SSB). The UE device 102 may have a measurement gap 216 using a neighboring cell frequency 217 during the SSB 204. The UE device 102 may have a pre-configured gap (PCG) 220 and a PCG 222 using a neighboring cell frequency 223. The PCG 220 may be during the SSB 212 and the SSB 208, and the PCG 222 may be during the SSB 214 and the SSB 210.

Still referring to FIG. 2, the UE device 102 may return to frequency f3 at step 230 from a frequency 231 (e.g., to measure the SSB 204 using the frequency f3) during the measurement gap 216. At step 232, the UE device 102 may perform a frequency measurement during the PCG 220 without a measurement gap. At step 234, the UE device 102 may receive a command (e.g., a DCI command from the gNB 104) to trigger BWP switching, at which time there may be a switching time delay. At step 236, using a different BWP 327, the UE device 102 may perform a frequency measurement using the PCG 222, and at step 238, using a different BWP, may perform a frequency measurement using the PCG 222.

In one or more embodiments, the PCGs may accommodate measurement gap configurations for dynamic situation for intra-frequency measurements with BWP switching. To facilitate the dynamic BWP switching situations, the PCGs may require further activation (e.g., when BWP switching). For example, the configuration for PCGs may use the MeasGapConfig flag described above, defining measurement gaps with MOs (e.g., the neighboring cell frequencies 207, 211, and 215 may be MOs). For example, the PCG configurations may look as follows:
MeasConfig::=SEQUENCE {
measObjectToRemoveList MeasObjectToRemoveList
OPTIONAL, -- Need N
measObjectToAddModList MeasObjectToAddModList
OPTIONAL, -- Need N
reportConfigToRemoveList ReportConfigToRemoveList
OPTIONAL, -- Need N
reportConfigToAddModList ReportConfigToAddModList
OPTIONAL, -- Need N
measIdToRemoveList MeasIdToRemoveList
OPTIONAL, -- Need N
measldToAddModList MeasIdToAddModList
OPTIONAL, -- Need N
s-MeasureConfig CHOICE {
ssb-RSRP RSRP-Range,
csi-RSRP RSRP-Range
}
OPTIONAL, -- Need M
quantityConfig QuantityConfig
OPTIONAL, -- Need M
measGapConfig MeasGapConfig
preconfigMG yes
OPTIONAL, -- Need M
measGapSharingConfig MeasGapSharingConfig
OPTIONAL, -- Need M
. . . ,
[[
interFrequencyConfig-NoGap-r16 ENUMERATED {true}
OPTIONAL -- Need R
]]

In this manner, the preconfigMG flag of measGapConfig (e.g., in a configuration message sent by the gNB 104 to the UE device 102) may indicate whether a measurement gap is pre-configured.

In one or more embodiments, measurement gap configuration may be based on associated BWPs. Whether a measurement gap is needed may be dependent on the relationship between the UE's active BWP and the measurement objects (e.g., the serving cell or neighbor cells). For example in FIG. 2, before the BWP switching there are three MOs (the neighboring cell frequencies 207, 211, and 215). MO1 (e.g., using the neighboring cell frequency 215) and MO2 (e.g., using the neighboring cell frequency 211) are the intra-f SSB measurements on the same frequency layers as that of the serving cell (e.g., in f0 and f1), and MO3 (e.g., using the neighboring cell frequency 217) is an inter-frequency SSB measurement. Thus, the legacy MGs may be associated with MO3 only before the BWP switching (e.g., at step 234). If the PCGs are supported by the 5 G network (e.g., the gNB 104) and the UE device 102, the PCGs may be configured when RRC connection is established or when reconfiguration occurs. For MO1 and MO2, the UE device 102 can perform the intra-frequency measurements. As a result, the PCG may not be activated before BWP switching. However, the PCG can be used for the measurements on MO1 and MO2 after the BWP switching, and UE device 102 may not perform the intra-frequency measurements on them because the relationship between MO1 and MO2 and the active BWP changed (e.g., a single pre-configured gap for MO1 and MO2).

In one or more embodiments, when MGs are defined-per BWP, multiple configurations of PCGs per BWP may be needed to arbitrate BWP switching. The network may need multiple patterns for each BWP switch, for example:
MeasConfig::=SEQUENCE {
measObjectToRemoveList MeasObjectToRemoveList
OPTIONAL, -- Need N
measObjectToAddModList MeasObjectToAddModList
OPTIONAL, -- Need N
reportConfigToRemoveList ReportConfigToRemoveList
OPTIONAL, -- Need N
reportConfigToAddModList ReportConfigToAddModList
OPTIONAL, -- Need N
measIdToRemoveList MeasIdToRemoveList
OPTIONAL, -- Need N
measIdToAddModList MeasIdToAddModList
OPTIONAL, -- Need N
s-MeasureConfig CHOICE {
ssb-RSRP RSRP-Range,
csi-RSRP RSRP-Range
}
OPTIONAL, -- Need M
quantityConfig QuantityConfig
OPTIONAL, -- Need M
measGapConfig MeasGapConfig
preconfmeasGapConfig {
BWP1
MO
MGRP,
OFFset
ON/OFF
}
preconfmeasGapConfig {
BWP2
MO
MGRP,
OFFset
}
preconfmeasGapConfig {
BWP3
MO
MGRP,
OFFset
}
preconfmeasGapConfig {
BWP4
MO
MGRP,
OFFset
} OPTIONAL, -- Need M
measGapSharingConfig MeasGapSharingConfig
OPTIONAL, -- Need M
. . . ,
[[
interFrequencyConfig-NoGap-r16 ENUMERATED {true}
OPTIONAL -- Need R
]]
}

In one or more embodiments, the gNB 104 may pre-configure the measurement gaps for the UE device 102. The PCGs may be configured prior to UE BWP switching (e.g., switching from the active BWP to another BWP as shown in FIG. 2). The PCGs may be associated with MOs that may be valid before and after BWP switching, and the MOs may be defined by frequency layer. The PCGs may be per UE and per FR, and may be associated with BWPs. For example, the PCGs may be configured for all BWPs that may be possibly activated.

In one or more embodiments, the PCGs may require additional activation and may be activated autonomously by the gNB 104 and the UE device 102. The gNB 104 may not schedule any transmission during a PCG after BWP switching. The UE device 102 may perform frequency measurements on target MOs with the PCG autonomously after BWP switching (e.g., during the PCG 222). To indicate or register a PCG's activation may or may not be updated to the gNB 104. The indication bit may be forwarded to the UE device 102 to cause the PCG activation, or may be requested by the UE device 102 for activation of the PCG.

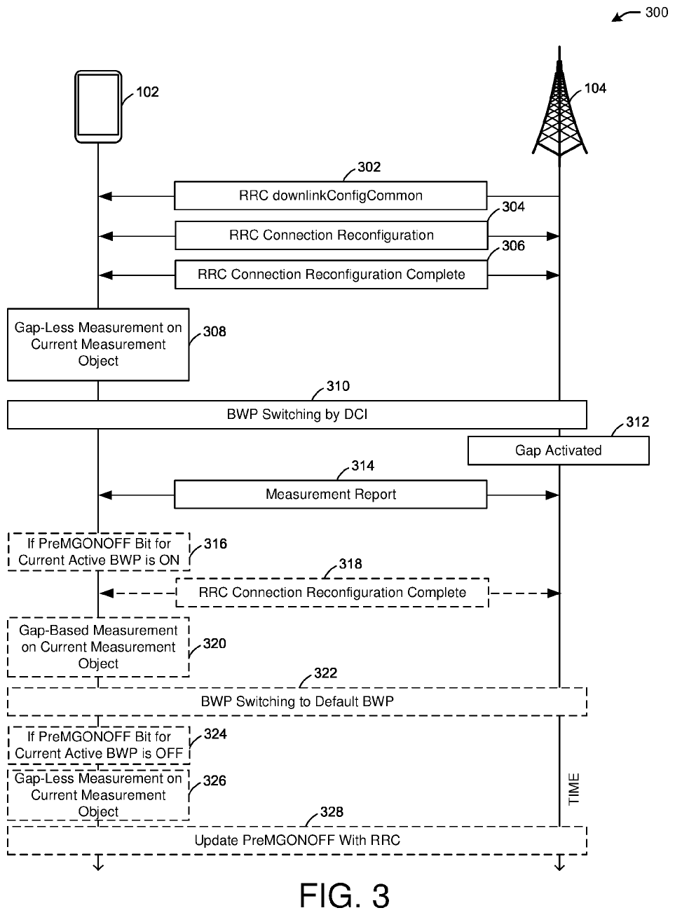

FIG. 3 illustrates a flow diagram of illustrative process 300 for using pre-configured measurement gap activation indications, in accordance with one or more example embodiments of the present disclosure.

Referring to FIG. 3, the process 300 may include the UE device 102 and the gNB 104 of FIG. 1. At step 302, the gNB 104 may send a downlinkConfigCommon (RRC) for an ith BWP. At step 304, the gNB 104 may provide a RRCConnectionReconfiguration {PreMGConfig} as described further below. At step 306, the RRC Connection Reconfiguration Complete may indicate that the reconfiguration of the RRC connection has completed. At step 308, the UE device 102 may perform a gap-less measurement on a current MO. At step 310, a DCI from the gNB 104 may trigger BWP switching by the UE device 102. At step 312, the gNB 104 may activate the measurement gap for the UE device 102. At step 314, the UE device 102 and the gNB 104 may exchange a measurement report for the MO measurement. At step 316, optionally, the PreMGONOFF bit for the current active BWP of the UE device 102 may be on, and at step 318, optionally, the RRC Connection Reconfiguration may be completed. At step 320, optionally, the UE device 102 may perform a gap-based measurement on the current MO. At step 322, optionally, the UE device 102 may perform BWP switching to a default BWP. At step 324, optionally, the PreMGONOFF bit for the current active BWP may be off, and at step 326, optionally, the UE device 102 may perform a gap-less measurement on the current MO. At step 328, optionally, the UE device 102 and the gNB 104 may update the PreMGONOFF with RRC.

In one or more embodiments, the PreMGConfig may look as follows:
MeasConfig::=SEQUENCE {
meas ObjectToRemoveList MeasObjectToRemoveList
OPTIONAL, -- Need N
. . . OPTIONAL, --
Need M
measGapConfig MeasGapConfig
OPTIONAL, -- Need M
. . .
}
MeasGapConfig::=SEQUENCE {
gapFR2 SetupRelease {GapConfig}
OPTIONAL, -- Need M
. . . ,
[[
gapFR1 SetupRelease {GapConfig}
OPTIONAL, -- Need M
gapUE SetupRelease {GapConfig}
OPTIONAL -- Need M
]]
PreMGONOFF N bits
}

In one or more embodiments, an ON/OFF bit may be forwarded to the UE device 102 by the gNB 104 to indicate to the UE device 1021 whether the PCGs shall be activated when BWP switching. There may be multiple (e.g., four) candidate BWPs, and the PCG activation indication may bet set as ON/OFF for each candidate BWP to which the UE device 102 may switch. During initial BWP configuration, the gNB 104 may need to configure the PCG and legacy measurement gaps. Based on the MO and active default BWP, the gNB 104 may indicate which bit in the bitmap may be ON or OFF. For example, the configuration may look as follows:
MeasConfig::=SEQUENCE {
measObjectToRemoveList MeasObjectToRemoveList
OPTIONAL, -- Need N
measObjectToAddModList MeasObjectToAddModList
OPTIONAL, -- Need N
reportConfigToRemoveList ReportConfigToRemoveList
OPTIONAL, -- Need N
reportConfigToAddModList ReportConfigToAddModList
OPTIONAL, -- Need N
measIdToRemoveList MeasIdToRemoveList
OPTIONAL, -- Need N
measldToAddModList MeasIdToAddModList
OPTIONAL, -- Need N
s-MeasureConfig CHOICE {
ssb-RSRP RSRP-Range,
csi-RSRP RSRP-Range
}
OPTIONAL, -- Need M
quantityConfig QuantityConfig
OPTIONAL, -- Need M
measGapConfig MeasGapConfig
OPTIONAL, -- Need M
measGapSharingConfig MeasGapSharingConfig
OPTIONAL, -- Need M
. . . ,
[[
interFrequencyConfig-NoGap-r16 ENUMERATED {true}
OPTIONAL -- Need R
}
MeasGapConfig::=SEQUENCE {
gapFR2 SetupRelease {GapConfig}
OPTIONAL, -- Need M
. . . ,
[[
gapFR1 SetupRelease {GapConfig}
OPTIONAL, -- Need M
gapUE SetupRelease {GapConfig}
OPTIONAL -- Need M
]]
PreMGONOFF N bits

The PreMGONOFF may be N bits (e.g., four bits). When the UE device's BWP may include the ongoing MO, the first bit may be OFF. Otherwise, the first bit may be ON.

In one or more embodiments, when the BWP switching is triggered by DCI, the UE may perform a gap-based measurement (e.g., step 320) on the configured MO if the activation indication bit for the BWP is ON. The activation indication bit may be provided to the UE device 102 prior to BWP switching (e.g., in the PCG configuration or in an earlier configuration).

In one or more embodiments, for the UE device's BWP configuration (e.g., the candidate BWP list), the activation indication bit (denoted PreMGONOFFBitMap) may be updated by RRC after the BWP configuration below changes:
DownlinkConfigCommon::=SEQUENCE {
frequencyInfoDL FrequencyInfoDL OPTIONAL, -
-Cond InterFreqHOAndServCellAdd
initialDownlinkBWP BWP-DownlinkCommon OPTIONAL, -
-Cond ServCellAdd
. . .
}

In one or more embodiments, when the UE's MO changes, the activation indication bit (denoted PreMGONOFFBitMap) may be updated by RRC with the BWP configuration.

In one or more embodiments, the PCGs may be configured by the gNB 104 prior to the UE device's active BWP switching. The gNB 104 may not schedule any data within a PCG after BWP switching. The PCG configuration may be associated with the MO (e.g., frequency carrier). The PCG configuration may include gap pattern information (e.g., measurement length, measurement periodicity), and the activation indication for all candidate UE BWPs. The activation indication may be the flag to distinguish from legacy MG configurations. The activation indication may be a bitmap for all candidate BWPs. The UE device 102 may perform measurements on target MOs with the PCG if the activation indication for the BWP switching is true. When the UE's candidate BWP is configured by RRC (e.g., DownlinkConfigCommon), the activation indication bits may be updated by RRC. When the UE's MO is reconfigured, the activation indication bits may be updated by the same RRC.

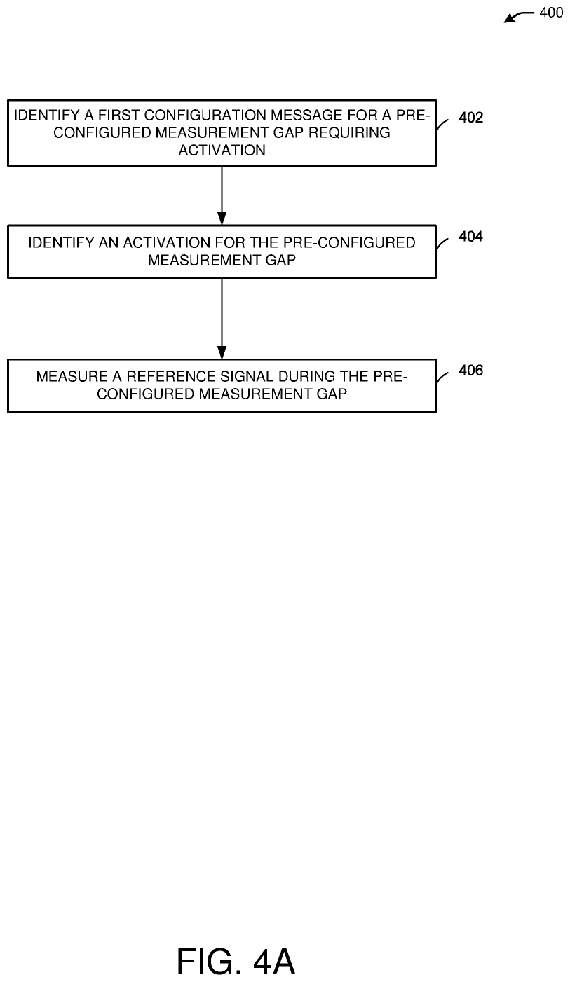

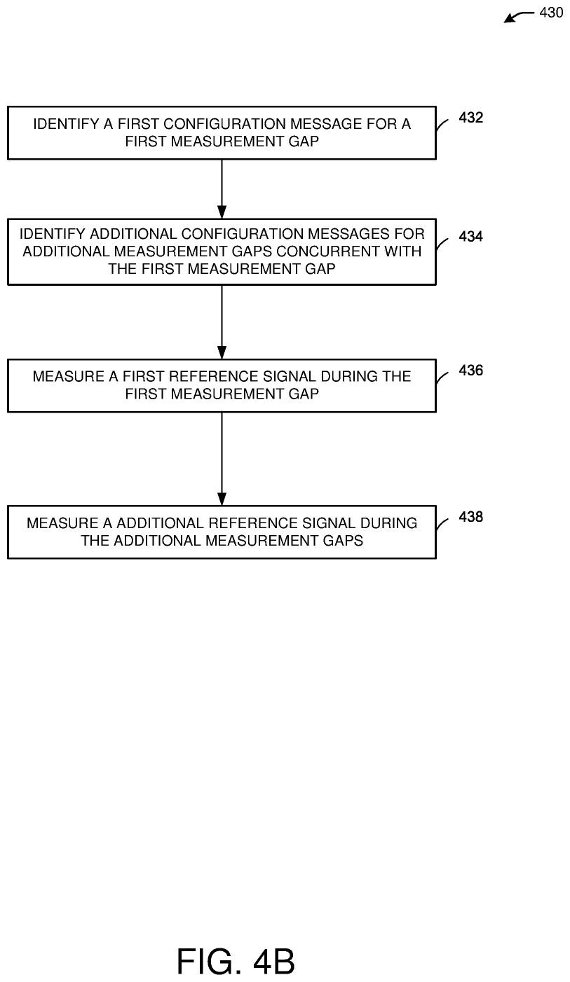

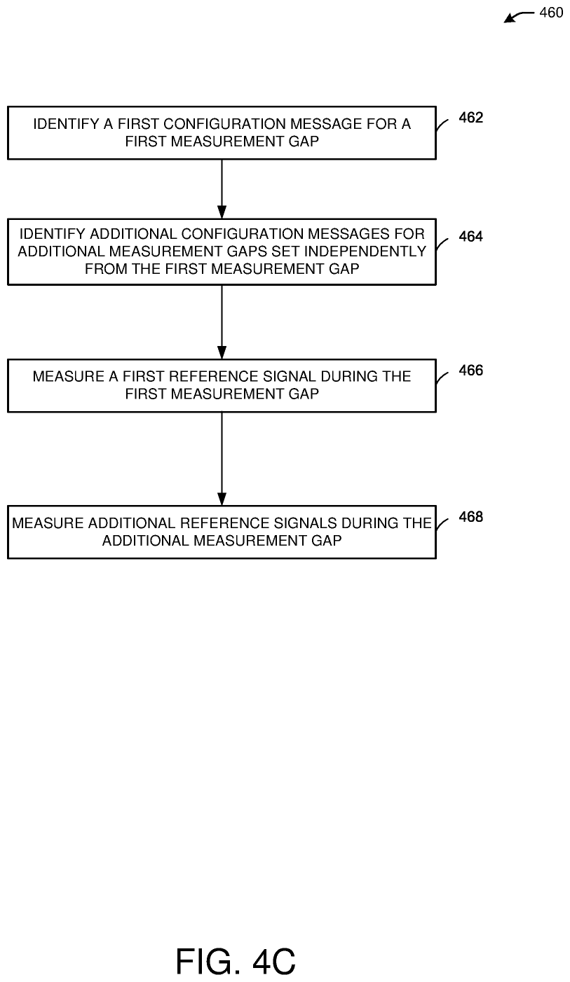

FIG. 4A illustrates a flow diagram of illustrative process 400 for using pre-configured measurement gaps, in accordance with one or more example embodiments of the present disclosure.

At block 402, a device (e.g., the UE device 102 of FIG. 1) may identify (e.g., detect and decode) a first configuration message, received from a network device (e.g., the gNB 104 of FIG. 1), for a pre-configured measurement gap requiring activation. For example, pre-configuration may be performed based on the description with respect to FIG. 2 and FIG. 3.

At block 404, the device may identify an activation indication for the pre-configured measurement gap (e.g., described with respect to FIG. 3).

At block 406, the device may measure a reference signal during the pre-configured measurement gap (e.g., described with respect to FIG. 2 and FIG. 3).

FIG. 4B illustrates a flow diagram of illustrative process 430 for using multiple concurrent measurement gaps, in accordance with one or more example embodiments of the present disclosure.

At block 432, a device (e.g., the UE device 102 of FIG. 1) may identify (e.g., detect and decode) a first configuration message for a first measurement gap (e.g., described with respect to FIG. 1).

At block 434, the device may identify additional configuration messages for additional measurement gaps concurrent with the first measurement gap (e.g., described with respect to FIG. 1).

At block 436, the device may measure a reference signal during the first measurement gap (e.g., described with respect to FIG. 1).

At block 438, the device may measure additional reference signals during the additional measurement gaps (e.g., described with respect to FIG. 1).

FIG. 4C illustrates a flow diagram of illustrative process 460 for using multiple independent measurement gaps, in accordance with one or more example embodiments of the present disclosure.

At block 462, a device (e.g., the UE device 102 of FIG. 1) may identify (e.g., detect and decode) a first configuration message for a first measurement gap (e.g., described with respect to FIG. 1).

At block 464, the device may identify additional configuration messages for additional measurement gaps set independently from the first measurement gap (e.g., described with respect to FIG. 1).

At block 466, the device may measure a reference signal during the first measurement gap (e.g., described with respect to FIG. 1).

At block 468, the device may measure additional reference signals during the additional measurement gaps (e.g., described with respect to FIG. 1).

The examples herein are not meant to be limiting.

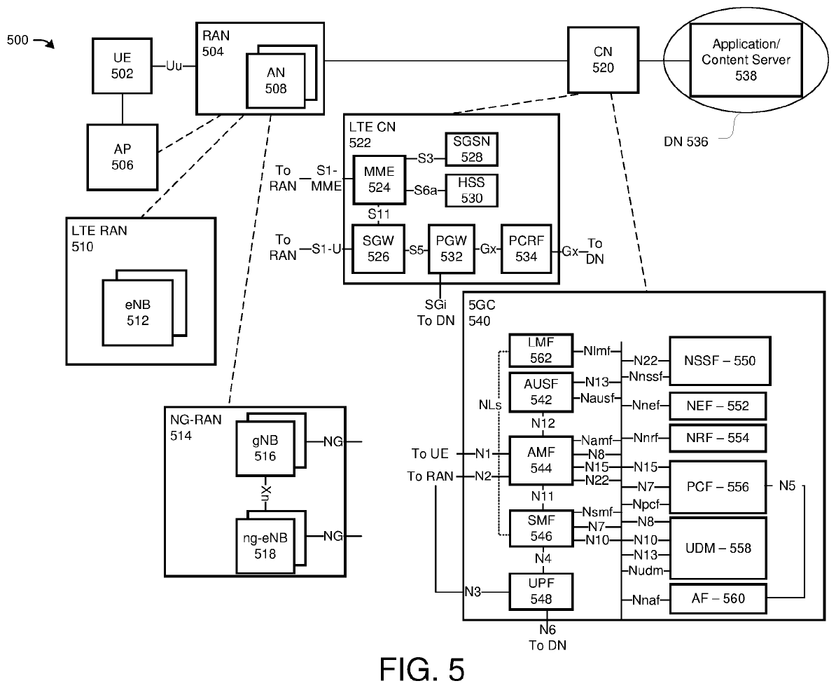

FIG. 5 illustrates a network 500, in accordance with one or more example embodiments of the present disclosure.

The network 500 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 500 may include a UE 502, which may include any mobile or non-mobile computing device designed to communicate with a RAN 504 via an over-the-air connection. The UE 502 may be communicatively coupled with the RAN 504 by a Uu interface. The UE 502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 502 may additionally communicate with an AP 506 via an over-the-air connection. The AP 506 may manage a WLAN connection, which may serve to offload some/all network traffic from the RAN 504. The connection between the UE 502 and the AP 506 may be consistent with any IEEE 802.11 protocol, wherein the AP 506 could be a wireless fidelity (Wi-Fi®) router. In some embodiments, the UE 502, RAN 504, and AP 506 may utilize cellular-WLAN aggregation (for example, LWA/LWIP). Cellular-WLAN aggregation may involve the UE 502 being configured by the RAN 404 to utilize both cellular radio resources and WLAN resources.

The RAN 504 may include one or more access nodes, for example, AN 508. AN 508 may terminate air-interface protocols for the UE 502 by providing access stratum protocols including RRC, PDCP, RLC, MAC, and L1 protocols. In this manner, the AN 508 may enable data/voice connectivity between CN 520 and the UE 502. In some embodiments, the AN 508 may be implemented in a discrete device or as one or more software entities running on server computers as part of, for example, a virtual network, which may be referred to as a CRAN or virtual baseband unit pool. The AN 508 be referred to as a BS, gNB, RAN node, eNB, ng-eNB, NodeB, RSU, TRxP, TRP, etc. The AN 508 may be a macrocell base station or a low power base station for providing femtocells, picocells or other like cells having smaller coverage areas, smaller user capacity, or higher bandwidth compared to macrocells.

In embodiments in which the RAN 504 includes a plurality of ANs, they may be coupled with one another via an X2 interface (if the RAN 504 is an LTE RAN) or an Xn interface (if the RAN 504 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 504 may each manage one or more cells, cell groups, component carriers, etc. to provide the UE 502 with an air interface for network access. The UE 502 may be simultaneously connected with a plurality of cells provided by the same or different ANs of the RAN 504. For example, the UE 502 and RAN 504 may use carrier aggregation to allow the UE 502 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 504 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 502 or AN 508 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 504 may be an LTE RAN 510 with eNBs, for example, eNB 512. The LTE RAN 510 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 504 may be an NG-RAN 514 with gNBs, for example, gNB 516, or ng-eNBs, for example, ng-eNB 518. The gNB 516 may connect with 5G-enabled UEs using a 5G NR interface. The gNB 516 may connect with a 5G core through an NG interface, which may include an N2 interface or an N3 interface. The ng-eNB 518 may also connect with the 5G core through an NG interface, but may connect with a UE via an LTE air interface. The gNB 516 and the ng-eNB 518 may connect with each other over an Xn interface.

In some embodiments, the NG interface may be split into two parts, an NG user plane (NG-U) interface, which carries traffic data between the nodes of the NG-RAN 514 and a UPF 548 (e.g., N3 interface), and an NG control plane (NG-C) interface, which is a signaling interface between the nodes of the NG-RAN 514 and an AMF 544 (e.g., N2 interface).

The NG-RAN 514 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 502 can be configured with multiple BWPs where each BWP configuration has a different SCS. When a BWP change is indicated to the UE 502, the SCS of the transmission is changed as well. Another use case example of BWP is related to power saving. In particular, multiple BWPs can be configured for the UE 502 with different amount of frequency resources (for example, PRBs) to support data transmission under different traffic loading scenarios. A BWP containing a smaller number of PRBs can be used for data transmission with small traffic load while allowing power saving at the UE 502 and in some cases at the gNB 516. A BWP containing a larger number of PRBs can be used for scenarios with higher traffic load.

The RAN 504 is communicatively coupled to CN 520 that includes network elements to provide various functions to support data and telecommunications services to customers/subscribers (for example, users of UE 502). The components of the CN 520 may be implemented in one physical node or separate physical nodes. In some embodiments, NFV may be utilized to virtualize any or all of the functions provided by the network elements of the CN 520 onto physical compute/storage resources in servers, switches, etc. A logical instantiation of the CN 520 may be referred to as a network slice, and a logical instantiation of a portion of the CN 520 may be referred to as a network sub-slice.

In some embodiments, the CN 520 may be an LTE CN 522, which may also be referred to as an EPC. The LTE CN 522 may include MME 524, SGW 526, SGSN 528, HSS 530, PGW 532, and PCRF 534 coupled with one another over interfaces (or “reference points”) as shown. Functions of the elements of the LTE CN 522 may be briefly introduced as follows.

The MME 524 may implement mobility management functions to track a current location of the UE 502 to facilitate paging, bearer activation/deactivation, handovers, gateway selection, authentication, etc.

The SGW 526 may terminate an Si interface toward the RAN and route data packets between the RAN and the LTE CN 522. The SGW 526 may be a local mobility anchor point for inter-RAN node handovers and also may provide an anchor for inter-3GPP mobility. Other responsibilities may include lawful intercept, charging, and some policy enforcement.

The SGSN 528 may track a location of the UE 502 and perform security functions and access control. In addition, the SGSN 528 may perform inter-EPC node signaling for mobility between different RAT networks; PDN and S-GW selection as specified by MME 524; MME selection for handovers; etc. The S3 reference point between the MME 524 and the SGSN 528 may enable user and bearer information exchange for inter-3GPP access network mobility in idle/active states.

The HSS 530 may include a database for network users, including subscription-related information to support the network entities' handling of communication sessions. The HSS 530 can provide support for routing/roaming, authentication, authorization, naming/addressing resolution, location dependencies, etc. An S6a reference point between the HSS 530 and the MME 524 may enable transfer of subscription and authentication data for authenticating/authorizing user access to the LTE CN 520.

The PGW 532 may terminate an SGi interface toward a data network (DN) 536 that may include an application/content server 538. The PGW 532 may route data packets between the LTE CN 522 and the data network 536. The PGW 532 may be coupled with the SGW 526 by an S5 reference point to facilitate user plane tunneling and tunnel management. The PGW 532 may further include a node for policy enforcement and charging data collection (for example, PCEF). Additionally, the SGi reference point between the PGW 532 and the data network 4 36 may be an operator external public, a private PDN, or an intra-operator packet data network, for example, for provision of IMS services. The PGW 532 may be coupled with a PCRF 534 via a Gx reference point.

The PCRF 534 is the policy and charging control element of the LTE CN 522. The PCRF 534 may be communicatively coupled to the app/content server 538 to determine appropriate QoS and charging parameters for service flows. The PCRF 532 may provision associated rules into a PCEF (via Gx reference point) with appropriate TFT and QCI.

In some embodiments, the CN 520 may be a 5GC 540. The 5GC 540 may include an AUSF 542, AMF 544, SMF 546, UPF 548, NSSF 550, NEF 552, NRF 554, PCF 556, UDM 558, AF 560, and LMF 562 coupled with one another over interfaces (or “reference points”) as shown. Functions of the elements of the 5GC 540 may be briefly introduced as follows.

The AUSF 542 may store data for authentication of UE 502 and handle authentication-related functionality. The AUSF 542 may facilitate a common authentication framework for various access types. In addition to communicating with other elements of the 5GC 540 over reference points as shown, the AUSF 542 may exhibit an Nausf service-based interface.

The AMF 544 may allow other functions of the 5GC 540 to communicate with the UE 502 and the RAN 504 and to subscribe to notifications about mobility events with respect to the UE 502. The AMF 544 may be responsible for registration management (for example, for registering UE 502), connection management, reachability management, mobility management, lawful interception of AMF-related events, and access authentication and authorization. The AMF 544 may provide transport for SM messages between the UE 502 and the SMF 546, and act as a transparent proxy for routing SM messages. AMF 544 may also provide transport for SMS messages between UE 502 and an SMSF. AMF 544 may interact with the AUSF 542 and the UE 502 to perform various security anchor and context management functions. Furthermore, AMF 544 may be a termination point of a RAN CP interface, which may include or be an N2 reference point between the RAN 504 and the AMF 544; and the AMF 544 may be a termination point of NAS (Ni) signaling, and perform NAS ciphering and integrity protection. AMF 544 may also support NAS signaling with the UE 502 over an N3 IWF interface.

The SMF 546 may be responsible for SM (for example, session establishment, tunnel management between UPF 548 and AN 508); UE IP address allocation and management (including optional authorization); selection and control of UP function; configuring traffic steering at UPF 548 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 544 over N2 to AN 508; and determining SSC mode of a session. SM may refer to management of a PDU session, and a PDU session or “session” may refer to a PDU connectivity service that provides or enables the exchange of PDUs between the UE 502 and the data network 536.

The UPF 548 may act as an anchor point for intra-RAT and inter-RAT mobility, an external PDU session point of interconnect to data network 536, and a branching point to support multi-homed PDU session. The UPF 548 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 548 may include an uplink classifier to support routing traffic flows to a data network.

The NSSF 550 may select a set of network slice instances serving the UE 502. The NSSF 550 may also determine allowed NSSAI and the mapping to the subscribed S-NSSAIs, if needed. The NSSF 550 may also determine the AMF set to be used to serve the UE 502, or a list of candidate AMFs based on a suitable configuration and possibly by querying the NRF 554. The selection of a set of network slice instances for the UE 502 may be triggered by the AMF 544 with which the UE 502 is registered by interacting with the NSSF 550, which may lead to a change of AMF. The NSSF 550 may interact with the AMF 544 via an N22 reference point; and may communicate with another NSSF in a visited network via an N31 reference point (not shown). Additionally, the NSSF 550 may exhibit an Nnssf service-based interface.

The NEF 552 may securely expose services and capabilities provided by 3GPP network functions for third party, internal exposure/re-exposure, AFs (e.g., AF 560), edge computing or fog computing systems, etc. In such embodiments, the NEF 452 may authenticate, authorize, or throttle the AFs. NEF 552 may also translate information exchanged with the AF 560 and information exchanged with internal network functions. For example, the NEF 552 may translate between an AF-Service-Identifier and an internal 5GC information. NEF 552 may also receive information from other NFs based on exposed capabilities of other NFs. This information may be stored at the NEF 552 as structured data, or at a data storage NF using standardized interfaces. The stored information can then be re-exposed by the NEF 552 to other NFs and AFs, or used for other purposes such as analytics. Additionally, the NEF 552 may exhibit an Nnef service-based interface.

The NRF 554 may support service discovery functions, receive NF discovery requests from NF instances, and provide the information of the discovered NF instances to the NF instances. NRF 554 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 554 may exhibit the Nnrf service-based interface.

The PCF 556 may provide policy rules to control plane functions to enforce them, and may also support unified policy framework to govern network behavior. The PCF 556 may also implement a front end to access subscription information relevant for policy decisions in a UDR of the UDM 558. In addition to communicating with functions over reference points as shown, the PCF 556 exhibit an Npcf service-based interface.

The UDM 558 may handle subscription-related information to support the network entities' handling of communication sessions, and may store subscription data of UE 502. For example, subscription data may be communicated via an N8 reference point between the UDM 558 and the AMF 544. The UDM 558 may include two parts, an application front end and a UDR. The UDR may store subscription data and policy data for the UDM 558 and the PCF 556, and/or structured data for exposure and application data (including PFDs for application detection, application request information for multiple UEs 502) for the NEF 552. The Nudr service-based interface may be exhibited by the UDR 221 to allow the UDM 558, PCF 556, and NEF 552 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 558 may exhibit the Nudm service-based interface.

The AF 560 may provide application influence on traffic routing, provide access to NEF, and interact with the policy framework for policy control.

In some embodiments, the 5GC 540 may enable edge computing by selecting operator/3rd party services to be geographically close to a point that the UE 502 is attached to the network. This may reduce latency and load on the network. To provide edge-computing implementations, the 5GC 540 may select a UPF 548 close to the UE 502 and execute traffic steering from the UPF 548 to data network 536 via the N6 interface. This may be based on the UE subscription data, UE location, and information provided by the AF 560. In this way, the AF 560 may influence UPF (re)selection and traffic routing. Based on operator deployment, when AF 560 is considered to be a trusted entity, the network operator may permit AF 560 to interact directly with relevant NFs. Additionally, the AF 560 may exhibit an Naf service-based interface.

The data network 536 may represent various network operator services, Internet access, or third party services that may be provided by one or more servers including, for example, application/content server 538.

The LMF 562 may receive measurement information (e.g., measurement reports) from the NG-RAN 514 and/or the UE 502 via the AMF 544. The LMF 562 may use the measurement information to determine device locations for indoor and/or outdoor positioning.

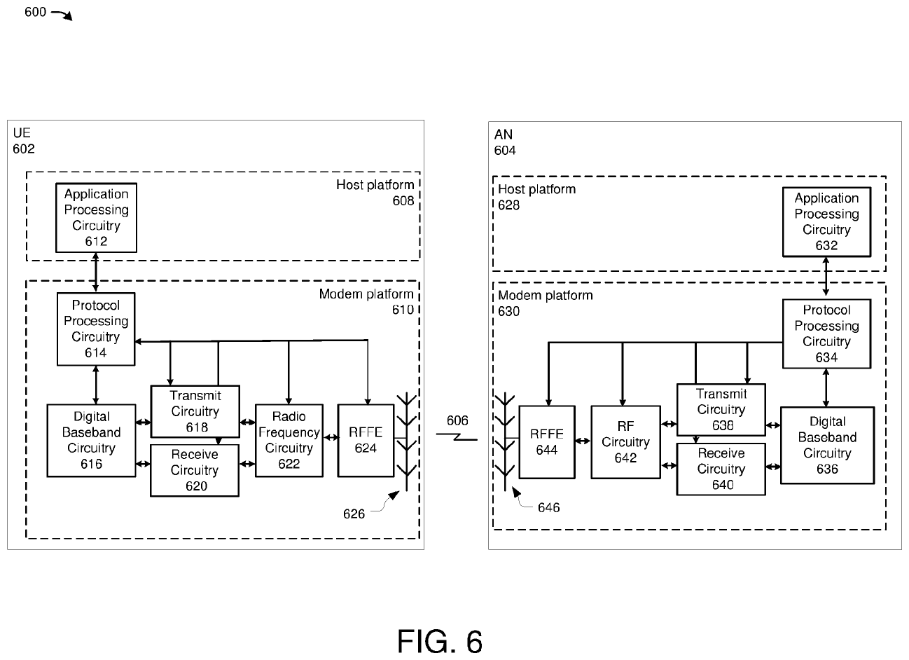

FIG. 6 schematically illustrates a wireless network 600, in accordance with one or more example embodiments of the present disclosure.

The wireless network 600 may include a UE 602 in wireless communication with an AN 604. The UE 602 and AN 604 may be similar to, and substantially interchangeable with, like-named components described elsewhere herein.

The UE 602 may be communicatively coupled with the AN 604 via connection 606. The connection 606 is illustrated as an air interface to enable communicative coupling, and can be consistent with cellular communications protocols such as an LTE protocol or a 5G NR protocol operating at mmWave or sub-6 GHz frequencies.

The UE 602 may include a host platform 608 coupled with a modem platform 610. The host platform 608 may include application processing circuitry 612, which may be coupled with protocol processing circuitry 614 of the modem platform 610. The application processing circuitry 612 may run various applications for the UE 602 that source/sink application data. The application processing circuitry 612 may further implement one or more layer operations to transmit/receive application data to/from a data network. These layer operations may include transport (for example UDP) and Internet (for example, IP) operations

The protocol processing circuitry 614 may implement one or more of layer operations to facilitate transmission or reception of data over the connection 606. The layer operations implemented by the protocol processing circuitry 614 may include, for example, MAC, RLC, PDCP, RRC and NAS operations.

The modem platform 610 may further include digital baseband circuitry 516 that may implement one or more layer operations that are “below” layer operations performed by the protocol processing circuitry 614 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 610 may further include transmit circuitry 618, receive circuitry 620, RF circuitry 622, and RF front end (RFFE) 624, which may include or connect to one or more antenna panels 626. Briefly, the transmit circuitry 618 may include a digital-to-analog converter, mixer, intermediate frequency (IF) components, etc.; the receive circuitry 620 may include an analog-to-digital converter, mixer, IF components, etc.; the RF circuitry 622 may include a low-noise amplifier, a power amplifier, power tracking components, etc.; RFFE 624 may include filters (for example, surface/bulk acoustic wave filters), switches, antenna tuners, beamforming components (for example, phase-array antenna components), etc. The selection and arrangement of the components of the transmit circuitry 618, receive circuitry 620, RF circuitry 622, RFFE 624, and antenna panels 626 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 614 may include one or more instances of control circuitry (not shown) to provide control functions for the transmit/receive components.

A UE reception may be established by and via the antenna panels 626, RFFE 624, RF circuitry 622, receive circuitry 620, digital baseband circuitry 616, and protocol processing circuitry 614. In some embodiments, the antenna panels 626 may receive a transmission from the AN 604 by receive-beamforming signals received by a plurality of antennas/antenna elements of the one or more antenna panels 626.

A UE transmission may be established by and via the protocol processing circuitry 614, digital baseband circuitry 616, transmit circuitry 618, RF circuitry 622, RFFE 624, and antenna panels 626. In some embodiments, the transmit components of the UE 504 may apply a spatial filter to the data to be transmitted to form a transmit beam emitted by the antenna elements of the antenna panels 626.

Similar to the UE 602, the AN 604 may include a host platform 628 coupled with a modem platform 630. The host platform 628 may include application processing circuitry 632 coupled with protocol processing circuitry 634 of the modem platform 630. The modem platform may further include digital baseband circuitry 636, transmit circuitry 638, receive circuitry 640, RF circuitry 642, RFFE circuitry 644, and antenna panels 646. The components of the AN 604 may be similar to and substantially interchangeable with like-named components of the UE 602. In addition to performing data transmission/reception as described above, the components of the AN 608 may perform various logical functions that include, for example, RNC functions such as radio bearer management, uplink and downlink dynamic radio resource management, and data packet scheduling.

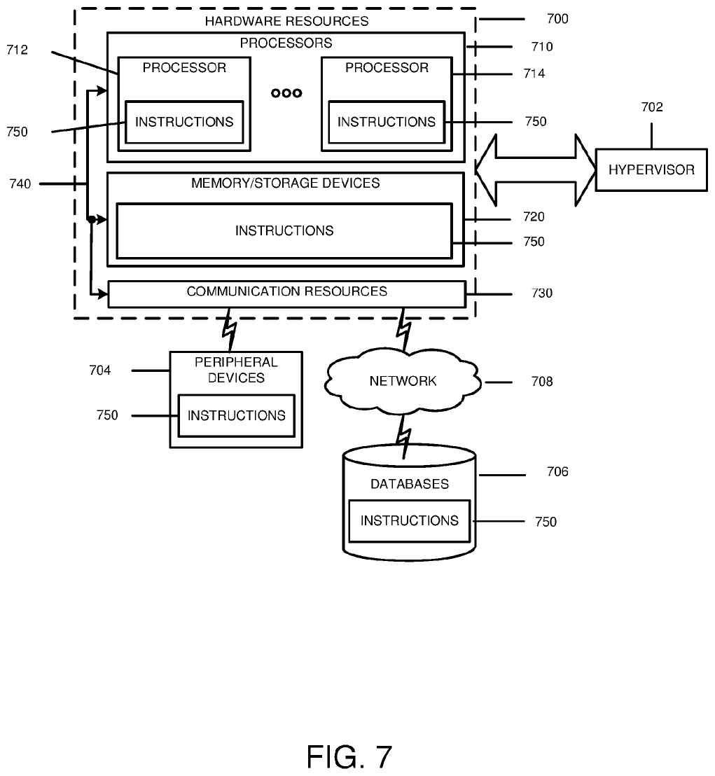

FIG. 7 is a block diagram 700 illustrating components, in accordance with one or more example embodiments of the present disclosure.

The components may be able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources including one or more processors (or processor cores) 710, one or more memory/storage devices 720, and one or more communication resources 730, each of which may be communicatively coupled via a bus 740 or other interface circuitry. For embodiments where node virtualization (e.g., NFV) is utilized, a hypervisor 702 may be executed to provide an execution environment for one or more network slices/sub-slices to utilize the hardware resources.

The processors 710 may include, for example, a processor 712 and a processor 714. The processors 710 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 720 may include main memory, disk storage, or any suitable combination thereof. The memory/storage devices 720 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 730 may include interconnection or network interface controllers, components, or other suitable devices to communicate with one or more peripheral devices 704 or one or more databases 706 or other network elements via a network 708. For example, the communication resources 730 may include wired communication components (e.g., for coupling via USB, Ethernet, etc.), cellular communication components, NFC components, Bluetooth® (or Bluetooth® Low Energy) components, Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources from any combination of the peripheral devices 704 or the databases 706. Accordingly, the memory of processors 710, the memory/storage devices 720, the peripheral devices 704, and the databases 706 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Various embodiments are described below.
Example 1 may be an apparatus of a user equipment device (UE) device for using measurement gaps, the apparatus comprising processing circuitry coupled to storage, the processing circuitry configured to: identify a configuration message, received from a 5G network device prior to switching from an active bandwidth part (BWP), for a pre-configured measurement gap during which the UE device is to perform an both gapless and gap-based frequency measurements, the configuration message indicating that the pre-configured measurement gap requires activation; identify an activation of the pre-configured measurement gap; and measure a reference signal during the pre-configured measurement gap.
Example 2 may include the apparatus of example 1 and/or some other example herein, wherein the configuration message is associated with a frequency associated with the reference signal.
Example 3 may include the apparatus of example 1 and/or some other example herein, wherein the configuration message is associated with a UE BWP associated.
Example 4 may include the apparatus of example 1 and/or some other example herein, wherein the reference signal is measured based on the pre-configured measurement gap after the UE device switches from the active BWP to one or more other candidate BWPs.
Example 5 may include the apparatus of any of examples 1-4 and/or some other example herein, wherein the configuration message comprises a PreConfigMG flag.
Example 6 may include the apparatus of any of examples 1-4 and/or some other example herein, wherein the configuration message comprises a bitmap.
Example 7 may include the apparatus of example 1 and/or some other example herein, wherein the configuration message comprises a measurement length and a measurement periodicity.
Example 8 may include a computer-readable storage medium comprising instructions to cause processing circuitry of a user equipment device (UE) device, upon execution of the instructions by the processing circuitry, to: identify a first configuration message, received from a 5G network device, for a first measurement gap during which the UE device is to perform a first gap-based frequency measurement; identify additional configuration messages, received from the 5G network device, for additional measurement gaps during which the UE device is to perform additional gap-based frequency measurements, wherein the first measurement gap and the additional measurement gaps are valid during a same time period; measure a first reference signal during the first measurement gap; and measure a second reference signal during the additional measurement gaps.
Example 9 may include the computer-readable medium of example 8 and/or some other example herein, wherein the same time period is set based on a measurement periodicity of the first measurement gap and the additional measurement gaps.
Example 10 may include the computer-readable medium of example 8 and/or some other example herein, wherein the first configuration message is associated with a first frequency associated with the first reference signal, and wherein the additional configuration messages are associated with another frequency associated with the reference signal.
Example 11 may include the computer-readable medium of example 8 and/or some other example herein, wherein the pre-configuration to be activated is associated with a UE's active bandwidth part (BWP) and with the reference signal.
Example 12 may include the computer-readable medium of example 8 and/or some other example herein, wherein the UE device is configured to switch an active BWP to another BWP.
Example 13 may include the computer-readable medium of any of examples 18-12 and/or some other example herein, wherein execution of the instructions further causes the processing circuitry to: identify an activation of the first measurement gap, wherein the activation and comprises at least one of a PreConfigMG flag or a bitmap.
Example 14 may include the computer-readable medium of any of examples 8-12 and/or some other example herein, wherein execution of the instructions further causes the processing circuitry to: identify a first activation of the first measurement gap; and identify a second activation of the second measurement gap.
Example 15 may include the computer-readable medium of example 8 and/or some other example herein, wherein the first configuration message and the additional configuration messages comprise a measurement length and a measurement periodicity.
Example 16 may include the computer-readable medium of example 8 and/or some other example herein, wherein the first measurement gap and the second measurement gap are independent of one another.
Example 17 may include a method for configuring measurement gaps, the method comprising: identifying, by processing circuitry of a user equipment (UE) device, a first configuration message, received from a 5G network device, for a first measurement gap during which the UE device is to perform a first intra-frequency measurement; identifying, by the processing circuitry, additional configuration messages, received from the 5G network device, for additional measurement gaps during which the UE device is to perform additional intra-frequency measurements, wherein the first measurement gap and the additional measurements gap are set independently from one another; measuring, by the processing circuitry, a first reference signal during the first measurement gap; and measuring, by the processing circuitry, additional reference signals during the additional measurement gaps.
Example 18 may include the method of example 17 and/or some other example herein, wherein the first configuration message is associated with a first frequency associated with the first reference signal, and wherein the other additional configuration is associated with an additional frequency associated with the second reference signal.
Example 19 may include the method of example 17 and/or some other example herein, wherein the first measurement gap and the additional measurement gaps are during a same time period.
Example 20 may include the method of example 19 and/or some other example herein, wherein the same time period is based on a periodicity associated with the first measurement gap.
Example 21 may include the method of example 17 and/or some other example herein, wherein a first time offset for the first measurement gap is different than a second time offset of one of the additional measurement gaps.
Example 22 may include the method of example 17 and/or some other example herein, wherein the UE device is configured to measure the first reference signal independently from measuring the additional reference signals.
Example 22 may include the method of example 17 and/or some other example herein, wherein the UE device is configured to measure the first reference signal independently from measuring the additional reference signals.
Example 23 may include the method of any of examples 17-22 and/or some other example herein, wherein the UE device is configured to measure the first reference signal independently from measuring the additional reference signals.
Example 24 may include one or more computer-readable media comprising instructions to cause an electronic device, upon execution of the instructions by one or more processors of the electronic device, to perform one or more elements of a method described in or related to any of examples 1-23, or any other method or process described herein
Example 25 may include an apparatus comprising logic, modules, and/or circuitry to perform one or more elements of a method described in or related to any of examples 1-23, or any other method or process described herein.
Example 26 may include a method, technique, or process as described in or related to any of examples 1-32, or portions or parts thereof.
Example 27 may include an apparatus comprising: one or more processors and one or more computer readable media comprising instructions that, when executed by the one or more processors, cause the one or more processors to perform the method, techniques, or process as described in or related to any of examples 1-23, or portions thereof.
Example 28 may include a method of communicating in a wireless network as shown and described herein.
Example 29 may include a system for providing wireless communication as shown and described herein.
Example 30 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

Unless used differently herein, terms, definitions, and abbreviations may be consistent with terms, definitions, and abbreviations defined in 3GPP TR 21.905 v16.0.0 (2019-06) and/or any other 3GPP standard. For the purposes of the present document, the following abbreviations (shown in Table 1) may apply to the examples and embodiments discussed herein.

TABLE 1
Abbreviations:

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour Relation |
| AP | Application Protocol, Antenna |
| | Port, Access Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service Provider |
| ASN.1 | Abstract Syntax Notation |
| | One |
| AUSF | Authentication Server Function |
| AWGN | Additive White Gaussian |
| | Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access |
| | Server |
| BSS | Business Support System |
| BS | Base Station |
| BSR | Buffer Status Report |
| BW | Bandwidth |
| BWP | Bandwidth Part |
| C-RNTI | Cell Radio Network Temporary |
| | Identity |
| CA | Carrier Aggregation, |
| | Certification Authority |
| CAPEX | CAPital EXpenditure |
| CBRA | Contention Based Random |
| | Access |
| CC | Component Carrier, Country |
| | Code, Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway Function |
| CHF | Charging Function |
| CI | Cell Identity |
| CID | Cell-ID (e.g., positioning |
| | method) |
| CIM | Common Information Model |
| CIR | Carrier to Interference Ratio |
| CK | Cipher Key |
| CM | Connection Management, |
| | Conditional Mandatory |
| CMAS | Commercial Mobile Alert |
| | Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, |
| | Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central |
| | Processing Unit |
| C/R | Command/Response field bit |
| CRAN | Cloud Radio Access Network, |
| | Cloud RAN |
| CRB | Common Resource Block |
| CRC | Cyclic Redundancy Check |
| CRI | Channel-State Information |
| | Resource Indicator, CSI-RS |
| | Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal received |
| | power |
| CSI-RSRQ | CSI reference signal received |
| | quality |
| CSI-SINR | CSI signal-to-noise and |
| | interference ratio |
| CSMA | Carrier Sense Multiple Access |
| CSMA/CA | CSMA with collision |
| | avoidance |
| CSS | Common Search Space, Cell- |
| | specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development Kit |
| DM-RS, DMRS | Demodulation Reference |
| | Signal |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel |
| | assessment, extended CCA |
| ECCE | Enhanced Control Channel |
| | Element, Enhanced CCE |
| ED | Energy Detection |
| EDGE | Enhanced Datarates for GSM |
| | Evolution (GSM Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting Environment |
| EGMF | Exposure Governance |
| | Management Function |
| EGPRS | Enhanced GPRS |
| EIR | Equipment Identity Register |
| eLAA | enhanced Licensed Assisted |
| | Access, enhanced LAA |
| EM | Element Manager |
| eMBB | Enhanced Mobile Broadband |
| EMS | Element Management System |
| eNB | evolved NodeB, E-UTRAN |
| | Node B |
| EN-DC | E-UTRA-NR Dual |
| | Connectivity |
| EPC | Evolved Packet Core |
| EPDCCH | enhanced PDCCH, enhanced |
| | Physical Downlink Control |
| | Cannel |
| EPRE | Energy per resource element |
| EPS | Evolved Packet System |
| EREG | enhanced REG, enhanced |
| | resource element groups |
| ETSI | European Telecommunications |
| | Standards Institute |
| ETWS | Earthquake and Tsunami |
| | Warning System |
| eUICC | embedded UICC, embedded |
| | Universal Integrated Circuit |
| | Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling Channel |
| FB | Functional Block |
| FBI | Feedback Information |
| FCC | Federal Communications |
| | Commission |
| FCCH | Frequency Correction CHannel |
| FDD | Frequency Division Duplex |
| FDM | Frequency Division Multiplex |
| FDMA | Frequency Division Multiple |
| | Access |
| FE | Front End |
| FEC | Forward Error Correction |
| FFS | For Further Study |
| FFT | Fast Fourier |
| | Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain Name |
| G-RNTI | GERAN Radio Network |
| | Temporary Identity |
| GERAN | GSM EDGE RAN, GSM EDGE |
| | Radio Access Network |
| GGSN | Gateway GPRS Support |
| | Node |
| GLONASSGLObal′naya | NAvigatsionnaya |
| | Sputnikovaya Sistema (Engl.: |
| | Global Navigation Satellite |
| | System) |
| gNB | Next Generation NodeB |
| gNB-CU | gNB-centralized unit, Next |
| | Generation NodeB centralized |
| | unit |
| gNB-DU | gNB-distributed unit, Next |
| | Generation NodeB distributed |
| | unit |
| GNSS | Global Navigation Satellite |
| | System |
| GPRS | General Packet Radio Service |
| GPSI | Generic Public Subscription |
| | Identifier |
| GSM | Global System for Mobile |
| | Communications, Groupe |
| | Spécial Mobile |
| GTP | GPRS Tunneling Protocol |
| GTP-U | GPRS Tunnelling Protocol |
| | for User Plane |
| GTS | Go To Sleep Signal (related |
| | to WUS) |
| GUMMEI | Globally Unique MME |
| | Identifier |
| GUTI | Globally Unique Temporary |
| | UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink Packet |
| | Access |
| HSN | Hopping Sequence Number |
| HSPA | High Speed Packet Access |
| HSS | Home Subscriber Server |
| HSUPA | High Speed Uplink Packet |
| | Access |
| HTTP | Hyper Text Transfer Protocol |
| HTTPS | Hyper Text Transfer Protocol |
| | Secure (https is http/1.1 over |
| | SSL, i.e. port 443) |
| I-Block | Information Block |
| ICCID | Integrated Circuit Card |
| | Identification |
| IAB | Integrated Access and Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical and |
| | Electronics Engineers |
| IEI | Information Element Identifier |
| IEIDL | Information Element Identifier |
| | Data Length |
| IETF | Internet Engineering Task |
| | Force |
| IF | Infrastructure |
| IM | Interference Measurement, |
| | Intermodulation, IP |
| | Multimedia |
| IMC | IMS Credentials |
| IMEI | International Mobile Equipment |
| | Identity |
| IMGI | International mobile group |
| | identity |
| IMPI | IP Multimedia Private Identity |
| IMPU | IP Multimedia PUblic identity |
| IMS | IP Multimedia Subsystem |
| IMSI | International Mobile Subscriber |
| | Identity |
| IoT | Internet of Things |
| IP | Internet Protocol |
| Ipsec | IP Security, Internet Protocol |
| | Security |
| IP-CAN | IP-Connectivity Access |
| | Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital |
| | Network |
| ISIM | IM Services Identity Module |
| ISO | International Organisation |
| | for Standardisation |
| ISP | Internet Service Provider |
| IWF | Interworking-Function |
| I-WLAN | Interworking WLAN |

Constraint length of the convolutional
code, USIM Individual key

| | |
|---|---|
| kB | Kilobyte (1000 bytes) |
| kbps | kilo-bits per second |
| Kc | Ciphering key |
| Ki | Individual subscriber |
| | authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal |
| | received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low |
| | Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level |
| | Integration with IPsec Tunnel |
| LTE | Long Term Evolution |
| M2M | Machine-to-Machine |
| MAC | Medium Access Control |
| | (protocol layering context) |
| MAC | Message authentication code |
| | (security/encryption context) |
| MAC-A | MAC used for authentication |
| | and key agreement (TSG T |
| | WG3 context) |
| MAC-I | MAC used for data integrity |
| | of signalling messages (TSG |
| | T WG3 context) |
| MANO | Management and Orchestration |
| MBMS | Multimedia Broadcast and |
| | Multicast Service |
| MBSFN | Multimedia Broadcast multicast |
| | service Single Frequency |
| | Network |
| MCC | Mobile Country Code |
| MCG | Master Cell Group |
| MCOT | Maximum Channel Occupancy |
| | Time |
| MCS | Modulation and coding scheme |
| MDAF | Management Data Analytics |
| | Function |
| MDAS | Management Data Analytics |
| | Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition |
| | Period |
| MIB | Master Information Block, |
| | Management Information Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile |
| | Originated |
| MPBCH | MTC Physical Broadcast |
| | CHannel |
| MPDCCH | MTC Physical Downlink |
| | Control CHannel |
| MPDSCH | MTC Physical Downlink |
| | Shared CHannel |
| MPRACH | MTC Physical Random |
| | Access CHannel |
| MPUSCH | MITC Physical Uplink |
| | Shared Channel |
| MPLS | MultiProtocol Label Switching |
| MS | Mobile Station |
| MSB | Most Significant Bit |
| MSC | Mobile Switching Centre |
| MSI | Minimum System Information, |
| | MCH Scheduling Information |
| MSID | Mobile Station Identifier |
| MSIN | Mobile Station |
| | Identification Number |
| MSISDN | Mobile Subscriber ISDN |
| | Number |
| MT | Mobile Terminated, Mobile |
| | Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up MTC |
| | WUS |
| NACK | Negative Acknowledgement |
| NAI | Network Access Identifier |
| NAS | Non-Access Stratum, Non- |
| | Access Stratum layer |
| NCT | Network Connectivity |
| | Topology |
| NC-JT | Non-Coherent Joint |
| | Transmission |
| NEC | Network Capabiltiy Exposure |
| NE-DC | NR-E-UTRA Dual |
| | Connectivity |
| NEF | Network Exposure Function |
| NF | Network Function |
| NFP | Network Forwarding Path |
| NFPD | Network Forwarding Path |
| | Descriptor |
| NFV | Network Functions |
| | Virtualization |
| NFVI | NFV Infrastructure |
| NFVO | NFV Orchestrator |
| NG | Next Generation, Next Gen |
| NGEN-DCNG-RAN | E-UTRA-NR Dual Connectivity |
| NM | Network Manager |
| NMS | Network Management System |
| N-PoP | Network Point of Presence |
| NMIB, N-MIB | Narrowband MIB |
| NPBCH | Narrowband Physical Broadcast |
| | CHannel |
| NPDCCH | Narrowband Physical Downlink |
| | Control CHannel |
| NPDSCH | Narrowband Physical Downlink |
| | Shared CHannel |
| NPRACH | Narrowband Physical Random |
| | Access CHannel |
| NPUSCH | Narrowband Physical Uplink |
| | Shared CHannel |
| NPSS | Narrowband Primary |
| | Synchronization Signal |
| NSSS | Narrowband Secondary |
| | Synchronization Signal |
| NR | New Radio, Neighbour |
| | Relation |
| NRF | NF Repository Function |
| NRS | Narrowband Reference Signal |
| NS | Network Service |
| NSA | Non-Standalone operation |
| | mode |
| NSD | Network Service Descriptor |
| NSR | Network Service Record |
| NSSAI | Network Slice Selection |
| | Assistance Information |
| S-NNSAI | Single-NSSAI |
| NSSF | Network Slice Selection |
| | Function |
| NW | Network |
| NWUS | Narrowband wake-up signal, |
| | Narrowband WUS |
| NZP | Non-Zero Power |
| O&M | Operation and Maintenance |
| ODU2 | Optical channel Data Unit - |
| | type 2 |
| OFDM | Orthogonal Frequency Division |
| | Multiplexing |
| OFDMA | Orthogonal Frequency Division |
| | Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal |
| | Computer |
| PCC | Primary Component Carrier, |
| | Primary CC |
| PCell | Primary Cell |
| PCI | Physical Cell ID, Physical |
| | Cell Identity |
| PCEF | Policy and Charging |
| | Enforcement Function |
| PCF | Policy Control Function |
| PCRFPolicy | Control and Charging |
| | Rules Function |
| PDCP | Packet Data Convergence |
| | Protocol, Packet Data |
| | Convergence Protocol layer |
| PDCCH | Physical Downlink Control |
| | Channel |
| PDCP | Packet Data Convergence |
| | Protocol |
| PDN | Packet Data Network, Public |
| | Data Network |
| PDSCH | Physical Downlink Shared |
| | Channel |
| PDU | Protocol Data Unit |
| PEI | Permanent Equipment |
| | Identifiers |
| PFD | Packet Flow Description |
| P-GW | PDN Gateway |
| PHICH | Physical hybrid-ARQ indicator |
| | channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function |
| | Descriptor |
| PNFR | Physical Network Function |
| | Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity- |
| | Based Service |
| PRS | Positioning Reference Signal |
| PRR | Packet Reception Radio |
| PS | Packet Services |
| PSBCH | Physical Sidelink Broadcast |
| | Channel |
| PSDCH | Physical Sidelink Downlink |
| | Channel |
| PSCCH | Physical Sidelink Control |
| | Channel |
| PSSCH | Physical Sidelink Shared |
| | Channel |
| PSCell | Primary SCell |
| PSS | Primary Synchronization |
| | Signal |
| PSTN | Public Switched Telephone |
| | Network |
| PT-RS | Phase-tracking reference |
| | signal |
| PTT | Push-to-Talk |
| PUCCH | Physical Uplink Control |
| | Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS Flow |
| | Identifier |
| QoS | Quality of Service |
| QPSK | Quadrature (Quaternary) Phase |
| | Shift Keying |
| QZSS | Quasi-Zenith Satellite System |
| RA-RNTI | Random Access RNTI |
| RAB | Radio Access Bearer, Random |
| | Access Burst |
| RACH | Random Access Channel |
| RADIUS | Remote Authentication Dial |
| | In User Service |
| RAN | Radio Access Network |
| RAND | RANDom number (used for |
| | authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio |
| | Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement |
| | Channel |
| RMSI | Remaining MSI, Remaining |
| | Minimum System |
| | Information |
| RN | Relay Node |
| RNC | Radio Network Controller |
| RNL | Radio Network Layer |
| RNTI | Radio Network Temporary |
| | Identifier |
| ROHC | RObust Header Compression |
| RRC | Radio Resource Control, Radio |
| | Resource Control layer |
| RRM | Radio Resource Management |
| RS | Reference Signal |
| RSRP | Reference Signal Received |
| | Power |
| RSRQ | Reference Signal Received |
| | Quality |
| RSSI | Received Signal Strength |
| | Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary Mobile Station |
| | Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, |
| | Secondary CC |
| SCell | Secondary Cell |
| SCEF | Service Capability Exposure |
| | Function |
| SC-FDMA | Single Carrier Frequency |
| | Division Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data Adaptation |
| | Protocol, Service Data |
| | Adaptation Protocol layer |
| SDL | Supplementary Downlink |
| SDNF | Structured Data Storage |
| | Network Function |
| SDP | Session Description Protocol |
| SDSF | Structured Data Storage |
| | Function |
| SDU | Service Data Unit |
| SEAF | Security Anchor Function |
| SeNB | secondary eNB |
| SEPP | Security Edge Protection |
| | Proxy |
| SFI | Slot format indication |
| SFTD | Space-Frequency Time |
| | Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement |
| | Timing Configuration |
| SN | Secondary Node, Sequence |
| | Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block |
| SSBRI | SS/PBCH Block Resource |
| | Indicator, Synchronization |
| | Signal Block Resource |
| | Indicator |
| SSC | Session and Service Continuity |
| SS-RSRP | Synchronization Signal based |
| | Reference Signal Received |
| | Power |
| SS-RSRQ | Synchronization Signal based |
| | Reference Signal Received |
| | Quality |
| SS-SINR | Synchronization Signal based |
| | Signal to Noise and |
| | Interference Ratio |
| SSS | Secondary Synchronization |
| | Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking |
| | Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration |
| | Indicator |
| TCP | Transmission |
| | Communication Protocol |
| TDD | Time Division Duplex |
| TDM | Time Division Multiplexing |
| TDMA | Time Division Multiple |
| | Access |
| TE | Terminal Equipment |
| TEID | Tunnel End Point Identifier |
| TFT | Traffic Flow Template |
| TMSI | Temporary Mobile Subscriber |
| | Identity |
| TNL | Transport Network Layer |
| TPC | Transmit Power Control |
| TPMI | Transmitted Precoding |
| | Matrix Indicator |
| TR | Technical Report |
| TRP, TRxP | Transmission Reception |
| | Point |
| TRS | Tracking Reference Signal |
| TRx | Transceiver |
| TS | Technical Specifications, |
| | Technical Standard |
| TTI | Transnlission Time Interval |
| Tx | Transmission, Transmitting, |
| | Transmitter |
| U-RNTI | UTRAN Radio Network |
| | Temporary Identity |
| UART | Universal Asynchronous |
| | Receiver and Transmitter |
| UCI | Uplink Control Information |
| UE | User Equipment |
| UDM | Unified Data Management |
| UDP | User Datagram Protocol |
| UDSF | Unstructured Data Storage |
| | Network Function |
| UICC | Universal Integrated |
| | Circuit Card |
| UL | Uplink |
| UM | Unacknowledged Mode |
| UML | Unified Modelling Language |
| UMTS | Universal Mobile |
| | Telecommunications System |
| UP | User Plane |
| UPF | User Plane Function |
| URI | Uniform Resource Identifier |
| URL | Uniform Resource Locator |
| URLLC | Ultra-Reliable and Low |
| | Latency |
| USB | Universal Serial Bus |
| USIM | Universal Subscrier Identity |
| | Module |
| USS | UF-specific search space |
| UTRA | UMTS Terrestrial Radio |
| | Access |
| UTRAN | Universal Terrestrial Radio |
| | Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure |
| | Manager |
| VL | Virtual Link, |
| VLAN | Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph |
| | Descriptor |
| VNFM | VNF Manager |
| VoIP | Voice-over-IP, Voice-over- |
| | Internet Protocol |
| VPLMN | Visited Public Land Mobile |
| | Network |
| VPN | Virtual Private Network |
| VRB | Virtual Resource Block |
| WiMAX | Worldwide Interoperability |
| | for Microwave Access |
| WLAN | Wireless Local Area Network |
| WMAN | Wireless Metropolitan Area |
| | Network |
| WPAN | Wireless Personal Area |
| | Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Po |

1. An apparatus of a user equipment device (UE) device for using measurement gaps, the apparatus comprising processing circuitry coupled to storage, the processing circuitry configured to:
identify a configuration message, received from a 5G network device prior to switching from an active bandwidth part (BWP), for a pre-configured measurement gap during which the UE device is to perform an both gapless and gap-based frequency measurements, the configuration message indicating that the pre-configured measurement gap requires activation;
identify an activation of the pre-configured measurement gap; and
measure a reference signal during the pre-configured measurement gap.

2. The apparatus of claim 1, wherein the configuration message is associated with a frequency associated with the reference signal.

3. The apparatus of claim 1, wherein the configuration message is associated with a UE BWP associated.

4. The apparatus of claim 1, wherein the reference signal is measured based on the pre-configured measurement gap after the UE device switches from the active BWP to one or more other candidate BWPs.

5. The apparatus of claim 1, wherein the configuration message comprises a PreConfigMG flag.

6. The apparatus of claim 1, wherein the configuration message comprises a bitmap.

7. The apparatus of claim 1, wherein the configuration message comprises a measurement length and a measurement periodicity.

8. A non-transitory computer-readable storage medium comprising instructions to cause processing circuitry of a user equipment device (UE) device, upon execution of the instructions by the processing circuitry, to:
identify a first configuration message, received from a 5G network device, for a first measurement gap during which the UE device is to perform a first gap-based frequency measurement;
identify additional configuration messages, received from the 5G network device, for additional measurement gaps during which the UE device is to perform additional gap-based frequency measurements, wherein the first measurement gap and the additional measurement gaps are valid during a same time period;
measure a first reference signal during the first measurement gap; and
measure a second reference signal during the additional measurement gaps.

9. The non-transitory computer-readable medium of claim 8, wherein the same time period is set based on a measurement periodicity of the first measurement gap and the additional measurement gaps.

10. The non-transitory computer-readable medium of claim 8, wherein the first configuration message is associated with a first frequency associated with the first reference signal, and wherein the additional configuration messages are associated with another frequency associated with the reference signal.

11. The non-transitory computer-readable medium of claim 8, wherein the pre-configuration to be activated is associated with a UE's active bandwidth part (BWP) and with the reference signal.

12. The non-transitory computer-readable medium of claim 8, wherein the UE device is configured to switch an active BWP to another BWP.

13. The non-transitory computer-readable medium of claim 12, wherein execution of the instructions further causes the processing circuitry to:
identify an activation of the first measurement gap,
wherein the activation and comprises at least one of a PreConfigMG flag or a bitmap.

14. The non-transitory computer-readable medium of claim 12, wherein execution of the instructions further causes the processing circuitry to:
identify a first activation of the first measurement gap; and
identify a second activation of the second measurement gap.

15. The non-transitory computer-readable medium of claim 8, wherein the first configuration message and the additional configuration messages comprise a measurement length and a measurement periodicity.

16. The non-transitory computer-readable medium of claim 8, wherein the first measurement gap and the second measurement gap are independent of one another.

17. A method for configuring measurement gaps, the method comprising:
identifying, by processing circuitry of a user equipment (UE) device, a first configuration message, received from a 5G network device, for a first measurement gap during which the UE device is to perform a first intra-frequency measurement;
identifying, by the processing circuitry, additional configuration messages, received from the 5G network device, for additional measurement gaps during which the UE device is to perform additional intra-frequency measurements, wherein the first measurement gap and the additional measurements gap are set independently from one another;
measuring, by the processing circuitry, a first reference signal during the first measurement gap; and
measuring, by the processing circuitry, additional reference signals during the additional measurement gaps.

18. The method of claim 17, wherein the first configuration message is associated with a first frequency associated with the first reference signal, and wherein the other additional configuration is associated with an additional frequency associated with the second reference signal.

19. The method of claim 17, wherein the first measurement gap and the additional measurement gaps are during a same time period.

20. The method of claim 19, wherein the same time period is based on a periodicity associated with the first measurement gap.

21-25. (canceled)
